(19) United States
(12) Patent Application Publication
(10) Pub. No.: US 2015/0186509 A1
(43) Pub. Date: Jul. 2, 2015

(54) POWER-EFFICIENT MUSIC PLAYLIST IDENTIFICATION

(71) Applicant: Google Inc., Mountain View, CA (US)

(72) Inventors: James F. Kelly, Milpitas, CA (US); Daniel R. Sandler, Watertown, MA (US); Glenn Kasten, San Mateo, CA (US)

(73) Assignee: Google Inc., Mountain View, CA (US)

(21) Appl. No.: 14/143,052

(22) Filed: Dec. 30, 2013

(51) Int. Cl. G06F 17/30; G10L 19/018

(52) U.S. Cl. CPC G06F 17/30743; G10L 19/018

(57) ABSTRACT

Methods, systems, and apparatus, including computer programs encoded on a computer storage medium, for power-efficient music playlist identification. In one aspect, a method includes the actions of receiving an audio recording of an item of media content. The actions further include determining, based on the audio recording, an identifier associated with the item of media content, and a timestamp. The actions further include determining, based on the identifier of the item of media content and the timestamp, an amount of remaining time that the item of media content has to play. The actions further include providing an indication for one or more components of a computing device to deactivate. The actions further include determining that the amount of time has elapsed. The actions further include providing an indication for the one or more components of the computing device to reactivate.

### TECHNICAL FIELD

This disclosure generally relates to media identification and, in one particular implementation, to reducing the power consumption of a device that may be identifying sequentially played songs.

### BACKGROUND

Many applications allow computing devices automatically identify songs. To do so, the user must activate a song identification service on a computing device, and must place the microphone of the computing device in a position where the computing device can record a short sound snippet of the song.

In response, the song identification service generates an audio fingerprint from the recorded sounds, and compares the audio fingerprint to a database of audio fingerprints that corresponds to a catalog of songs. If the song identification service identifies a match between the generated audio fingerprint and a particular audio fingerprint stored in the database, then the song identification application can display, on the display of the computing device, the name, the artist, and any other relevant information associated with the song whose particular audio fingerprint best matches the generated audio fingerprint.

### SUMMARY

According to an innovative aspect of the subject matter described in this specification, a computing device may receive an audio input and may identify a song associated with the audio input based on matching an audio fingerprint associated with the audio input to an audio fingerprint of the song. Once the computing device identifies the song, the computing device stores data that identifies the song, for later retrieval or use by the computing device or the user of the computing device.

In addition to identifying the song using the audio fingerprint, the computing device may determine which portion of the song to which the audio fingerprint corresponds and, if the duration of the song is known, a length of the song that remains to be played. Before attempting to recognize an additional song that may play after the song, and to conserve power, the computing device may power down an audio subsystem of the computing device for the remaining period of time left in the song. Once the remaining period of time has elapsed, the computing device may power up the audio subsystem, may identify the next song based on an audio fingerprint of the newly received audio input, and may store data that identifies the next song.

The computing device may continue to attempt to identify songs, and may power up or down the audio subsystem, until instructed by a user to stop identifying songs, or until no further songs are detected. In instances when no following song plays, or when the computing device is unable to identify a following song, the computing device may power down the audio subsystem for another period of time and then, once the particular period of time has elapsed, may power up the audio subsystem to try to determine if a next song is playing. If the computing device is unable to identify a song for an extended period of time, then the computing device may stop attempting to identify songs.

When requested by the user, for example on the following day, the computing device can display the list of songs that the device has identified, e.g. by accessing the stored data that identifies the recognized songs. The list can include the name of the song, the artist, and the time the song was played. The list may also include links that the user can select to purchase each song, or other information.

In general, another innovative aspect of the subject matter described in this specification may be embodied in methods that include the actions of receiving, by a computing device, an audio recording of an item of media content; determining, based on the audio recording, an identifier associated with the item of media content, and a timestamp; determining, based on the identifier of the item of media content and the timestamp, an amount of remaining time that the item of media content has to play; in response to determining the amount of remaining time that the item of media content has to play, providing an indication for one or more components of the computing device to deactivate; determining that the amount of time has elapsed; and in response to determining that the amount of time has elapsed, providing an indication for the one or more components of the computing device to reactivate.

These and other embodiments can each optionally include one or more of the following features. The action of determining an identifier associated with the item of media content, and a timestamp includes determining an audio fingerprint of the item of media content; comparing the audio fingerprint of the item of media content to one or more audio fingerprints; and based on comparing the audio fingerprint of the item of media content to the one or more audio fingerprints, determining an identifier associated with the item of media content. The action of comparing the audio fingerprint of the item of media content to one or more audio fingerprints includes determining a confidence score, and where determining an identifier associated with the item of media content, and a timestamp is based further on determining that the confidence score satisfies a threshold.

The action of determining that the amount of time has elapsed includes accessing a media item knowledge base that contains data associated with one or more items of media content. The action of providing an indication for one or more components of the computing device to deactivate includes providing an indication to deactivate one or more of a microphone, an analog-to-digital converter, or an audio buffer. The item of media content is a song, a commercial, or a movie trailer. The actions further include accessing data associated with the item of media content from a media item knowledge base that contains data associated with one or more items of media content; storing the data associated with the item of media content; receiving a request to display the data associated with the item of media content; and displaying the data associated with the item of media content.

The action of providing an indication for one or more components of the computing device to deactivate includes providing an indication for the one or more components of the computing device to reduce a power consumption of the computing device. The action of providing an indication for one or more components of the computing device to deactivate includes providing an indication for the one or more components of an audio subsystem of the computing device to deactivate. The action of providing an indication for the one or more components of the computing device to reactivate includes providing an indication for the one or more components of the audio subsystem of the computing device to reactivate.

In general, another innovative aspect of the subject matter described in this specification may be embodied in methods that include the actions of receiving, by a computing device, an audio recording of a an item of media content; determining, based on the audio recording, an identifier associated with the item of media content, and a timestamp; determining, based on the identifier of the item of media content and the timestamp, an amount of remaining time that the item of media content has to play; determining that the amount of time has elapsed; and in response to determining that the amount of time has elapsed, providing an indication for the one or more components of the computing device to reactivate.

These and other embodiments can each optionally include one or more of the following features. The action of determining an identifier associated with the item of media content, and a timestamp includes determining an audio fingerprint of the item of media content; comparing the audio fingerprint of the item of media content to one or more audio fingerprints; and based on comparing the audio fingerprint of the item of media content to the one or more audio fingerprints, determining an identifier associated with the item of media content. The action of comparing the audio fingerprint of the item of media content to one or more audio fingerprints includes determining a confidence score.

The action of determining an identifier associated with the item of media content, and a timestamp is based further on determining that the confidence score satisfies a threshold. The action of determining that the amount of time has elapsed includes accessing a media item knowledge base that contains data associated with one or more items of media content. The action of providing an indication for the one or more components of the computing device to reactivate includes providing an indication to reactivate one or more of a microphone, an analog-to-digital converter, or an audio buffer. The item of media content is a song, a commercial, or a movie trailer. The actions further include accessing data associated with the item of media content from a media item knowledge base that contains data associated with one or more items of media content; storing the data associated with the item of media content; receiving a request to display the data associated with the item of media content; and displaying the data associated with the item of media content.

The action of providing an indication for the one or more components of the computing device to reactivate includes providing an indication for the one or more components of the computing device to increase a power consumption of the one or more components of the computing device. The action of providing an indication for the one or more components of the computing device to reactivate includes providing an indication for the one or more components of the computing device to reactivate.

In general, another innovative aspect of the subject matter described in this specification may be embodied in methods that include the actions of receiving, by a computing device, an audio recording of a an item of media content; determining, based on the audio recording, an identifier associated with the item of media content, and a timestamp; determining, based on the identifier of the item of media content and the timestamp, an amount of time that the item of media content has to play; and providing an indication for one or more components of the computing device to deactivate for the amount of time.

These and other embodiments can each optionally include one or more of the following features. The action of determining an identifier associated with the item of media content, and a timestamp includes determining an audio fingerprint of the item of media content; comparing the audio fingerprint of the item of media content to one or more audio fingerprints; and based on comparing the audio fingerprint of the item of media content to the one or more audio fingerprints, determining an identifier associated with the item of media content. The action of comparing the audio fingerprint of the item of media content to one or more audio fingerprints includes determining a confidence score.

The action of determining an identifier associated with the item of media content, and a timestamp is based further on determining that the confidence score satisfies a threshold. The action of providing an indication for one or more components of the computing device to deactivate providing an indication to deactivate one or more of a microphone, an analog-to-digital converter, or an audio buffer. The item of media content is a song, a commercial, or a movie trailer. The actions further include accessing data associated with the item of media content from a media item knowledge base that contains data associated with one or more items of media content; storing the data associated with the item of media content; receiving a request to display the data associated with the item of media content; and displaying the data associated with the item of media content.

The action of providing an indication for one or more components of the computing device to deactivate includes providing an indication for the one or more components of the computing device to reduce a power consumption of the one or more components of the audio subsystem. The action of providing an indication for one or more components of the computing device to deactivate includes providing an indication for one or more components of an audio subsystem of the computing device to deactivate.

Other embodiments of this aspect include corresponding systems, apparatus, and computer programs recorded on computer storage devices, each configured to perform the operations of the methods.

Particular embodiments of the subject matter described in this specification can be implemented so as to realize one or more of the following advantages. A computing device can identify a list of songs without continuously recording audio, and without unnecessarily draining the battery of the computing device.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of a device identifying a playlist in a power efficient manner.

FIG. 2 is a diagram of an example system for identifying a playlist in a power efficient manner.

FIG. 3 is a diagram of an example process for power efficient identification of a playlist.

Like reference numbers and designations in the various drawings indicate like elements.

### DETAILED DESCRIPTION

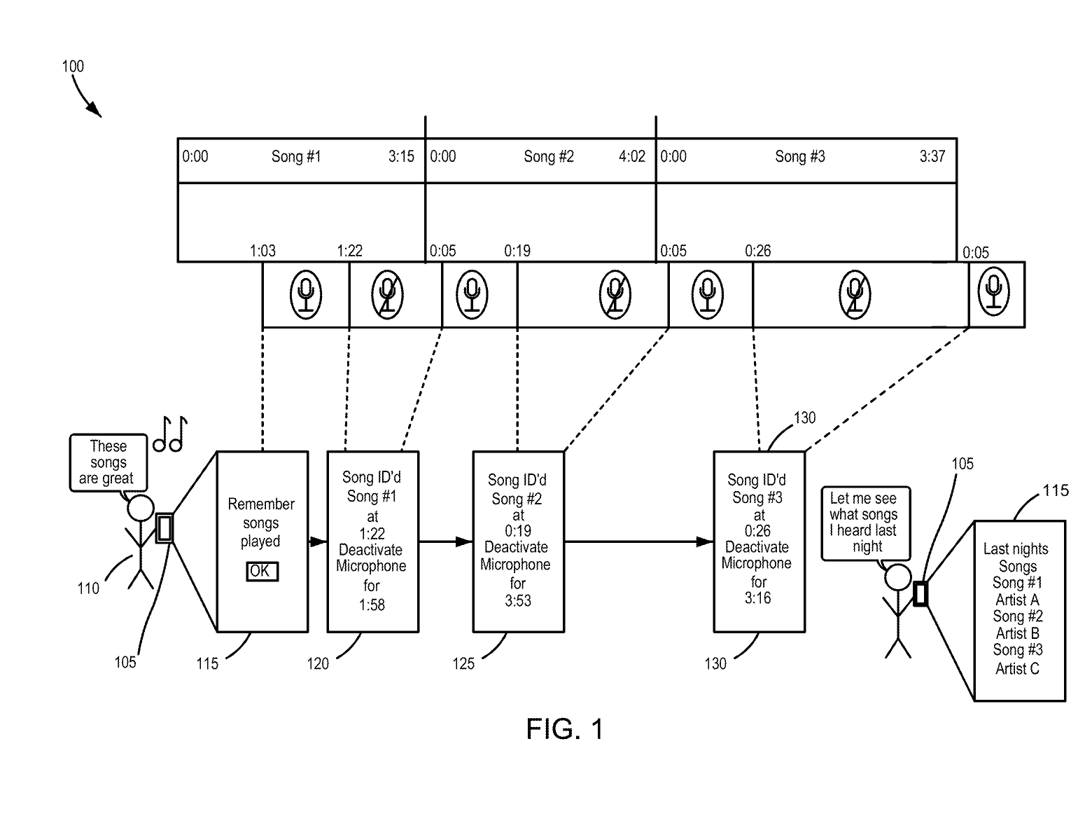

FIG. 1 illustrates a diagram 100 of a device 105 that identifies a playlist of songs in a power-efficient manner. In general, the device 105 receives audio through a microphone of the device 105 and identifies an item of media content that corresponds to the audio input. An item of media content may include a commercial, a movie trailer, or any other similar items of known length. The device 105 identifies the item of media content by generating an audio fingerprint of the item of media content and comparing that audio fingerprint to audio fingerprints that are associated with different items of media content. The device 105 indicates information associated with the identified item of media content to the user 110, e.g., the song name. The device 105 determines which portion of the item of media content to which the received audio corresponds and a timestamp associated with the received audio.

The device 105 accesses a database to determine the length, e.g. a playing time, of the item of media content. Using a play time corresponding with the portion of the item of media content to which the received audio corresponds and the length of the item of media content, the device 105 can determine the length of remaining time that the item of media content has to play. The device 105 can then deactivate certain components of an audio subsystem of the device 105 to conserve power.

Based on the deactivation time and the length of remaining time that the item of media content has to play, the device 105 can determine a time when the item of media content is expected to have finished playing. Once the time is reached, the device 105 can reactivate the audio subsystem to identify another item of media content by reiterating the audio fingerprinting, media identification, and timestamp identification processes. The device 105 may stop identifying items of media content when the device receives instructions from a user or when the device has been unable to identify an item of media content for a particular period of time. After the device 105 has completed identifying items of media content, the user 110 may view on the device 105 a list 115 of the items of media content identified by the device 105.

In more detail, the device 105, which may include a mobile phone, a tablet device, a wearable computer, or any other computing device, receives an instruction from the user 110 to begin identifying items of media content. For example, as shown in screen 115, the user 110 may select a control to instruct the device 105 to identify the songs currently playing outside of the device 105. The device 105 records portions of the items of media content through a microphone of the device or through a device plugged into an input port of the device such as an audio jack.

In FIG. 1, the user 110 is listening to Song #1, and instructs the device 105 to identify the song or songs that are being played. The device 105, after receiving an instruction from the user, records an audio snippet of Song #1 using the microphone, generates an audio fingerprint from the snippet, and identifies the song as Song #1 using audio fingerprinting techniques. The audio fingerprint may be generated based on tempo, average frequency spectrum, prominent tones, bandwidth, and/or other audio characteristics.

The device 105 may compare the audio fingerprint to a database containing other audio fingerprints and corresponding identities and, based on that comparison, may identify the song as Song #1. In some implementations, the comparison of the determined fingerprint and the audio fingerprints involves determining a confidence score. If the confidence score for the comparison of the determined fingerprint and an audio fingerprint in the database satisfies a threshold, then the device determines that the determined fingerprint and the audio fingerprint in the database match. For example, the device may determine an audio fingerprint for Song #1. The device may compare the audio fingerprint for Song #1 to audio fingerprints in an audio fingerprint database that is accessible over the network. The device may determine that the comparison of the audio fingerprint for Song #1 and an audio fingerprint from the database corresponding to “Birthday Song” has a confidence score of eighty-five. If the threshold is eighty, then the device determines that the two audio fingerprints match. The device determines that Song #1 is “Birthday Song.”

The device 105 also determines that the recorded portion of Song #1 corresponds to the portion of the song between 1:03 and 1:22 as well as timestamps associated with the portion of the song. The device 105 may access a database to determine the length of Song #1. The device 105 may determine the length of time remaining in Song #1 by subtracting the end time of the recorded portion of the song from the length of the song. For Song #1, the remaining time is one minute and fifty-three seconds

The device 105 deactivates certain components of the audio subsystem of the device 105 for at least the remaining period of play for Song #1. The audio subsystem receives and process audio received through the microphone or an input port. In some implementations, the device 105 deactivates the audio subsystem of device 105 for the remaining period of play for the identified song plus an additional period of time. For example, the device 105 may deactivate the audio subsystem of the device 105 for an additional five seconds. After identifying the song, the device 105 may display the name of the song and the amount of time that the device 105 may deactivate the audio subsystem as shown in screen 120.

When the device 105 deactivates the audio subsystem, the device 105 determines a time associated with the deactivation. The device compares the deactivation time to the time remaining for the item of media content. If the two time are different, then the device 105 adjusts the deactivation period for the audio subsystem. For example, if the device 105 received the last portion of the received audio at a time of 4:13:35 and the device 105 deactivated the audio subsystem at a time of 4:13:37, then the device would subtract two seconds from the deactivation time. Once the device 105 has deactivated the audio subsystem, the device sets a reminder to reactivate the audio subsystem at the time of the deactivation time plus the time remaining for the item of media content. For Song #1, the timestamp associated with the deactivation may be 4:13:37 and the device 105 determines to deactivate the audio subsystem one minute and fifty-eight seconds. When combined, the reactivation time for the audio subsystem is 4:15:35.

In some implementations, deactivating the audio subsystem allows the device 105 to conserve battery power by powering down the audio subsystem or placing the audio subsystem in a low power state. In other implementations, deactivating the audio subsystem allows the device 105 to avoid recording and processing unnecessary audio and therefore allow save processing power of the device 105. In some implementations, deactivating the audio subsystem improves privacy by preventing the microphone from continuously receiving and processing audio that are unrelated to the music identification process.

The device 105 reactivates the audio subsystem at a time of 4:15:35 so that the device 105 may identify the next song playing. The device 105 receives an audio snippet corresponding to Song #2 though the microphone of the device 105 and after fourteen seconds of Song #2, the device 105 deactivates the audio subsystem of the device 105.

As before with Song #1, the device 105 determines the remaining amount of play in Song #2 by accessing a database. For Song #2, the device 105 determines that there are three minutes, forty-eight seconds remaining. The device 105 may add additional time to the remaining play time of Song #2 and deactivate the microphone of device 105 for three minutes and fifty-three seconds. The device may display the identification of Song #2 and an indication of the amount of time that the microphone will be deactivated in screen 125.

The device repeats the process used to recognize Song #1 and Song #2 and uses the process to identify Song #3. The device 105 may display the identity of Song #3 and the amount of time that the device 105 will deactivate the audio subsystem in screen 130.

The device 105 may stop identifying songs when instructed by the user or when the device 105 is no longer able to recognize songs from the received audio. In some implementations, the device 105 may stop identifying media items when the user 110 instructs, through a touch screen or other input device, the device 105 to stop identifying songs. For example, the user may have been listening to songs at a bar and instructed the device to remember the list of songs being played. Once the user leaves the bar, the user may instruct the device to stop identifying songs. In some implementations, the device 105 may stop identifying media items when the device does not detect audio that corresponds to items of media content through the microphone for a particular period of time. For example, the device 105 may deactivate the microphone for three minutes and sixteen seconds. Upon reactivation of the microphone, the device 105 may not detect any songs for two minutes. After two minutes of not detecting any songs, the device 105 may stop identifying more songs. In some instances, the device 105 may identify the same item of media content that the device 105 previously identified. For example, the device may identify “Birthday Song” and then after “Birthday Song” is expected to be complete, the device identifies “Birthday Song” again. In this case, the device 105 may deactivate the audio subsystem for a particular amount of time, such as thirty seconds, and then reactivate the audio subsystem to identify an item of media content corresponding to the subsequently received audio.

In some implementations, the device 105 stores the list of identified media items in a storage medium within the device 105. The device 105 may label the list of identified media items by the date identified and the user can select a previously identified list to view the list of identified media items. For example, the day following the identifying of Song #1, Song #2, and Song #3, the user 110 may instruct the device 105 to show the user 110 the list of songs played the night before. The device 105 may display the list of songs as shown in screen 115.

In some implementations, when the device 105 displays the list of identified media items, the list includes links to purchase the media items or items associated with the media items. For example, with songs or movie trailers, the list may include links to purchase the songs or movies. With commercials, the list may include links to purchase products advertised in the commercials. The list may also include advertisements associated with the items of media content. For example, if the list includes jazz songs, the list may include advertisements for other jazz songs or artists or links to purchase other jazz songs. Similarly, a list may include links to purchase songs that were not played but are from the same artist as those songs on the list or include links to purchase songs from the same album or the entire album. The list may include links to execute search queries associated with the songs. For example, if the list contains songs from the Joe Smith Band, the list may include a link to the Joe Smith Band website.

The list may be used by an advertising server to decide what advertisements to serve to the user. The list may also include a knowledge panel that is associated with each item of media content. For example, the list may include “Birthday Song” by the Joe Smith Band and the list may include additional information about “Birthday Song” including the album, release date, length, record label, genre, writer, producer or any other pertinent information. The list may also include the opportunity to rate each item of media content. For example, the list may include the opportunity to rank a particular song on a scale of one to five and to include a review. In some implementations, the list may include a list of other users from the user's social network who may be associated with the same list of items of media content. For example, two users who are connected in a social network attend the same concert and instruct their respective devices to remember the songs played. When the users view the list of songs the following day the list may indicate that the user's friend may have been at the same concert.

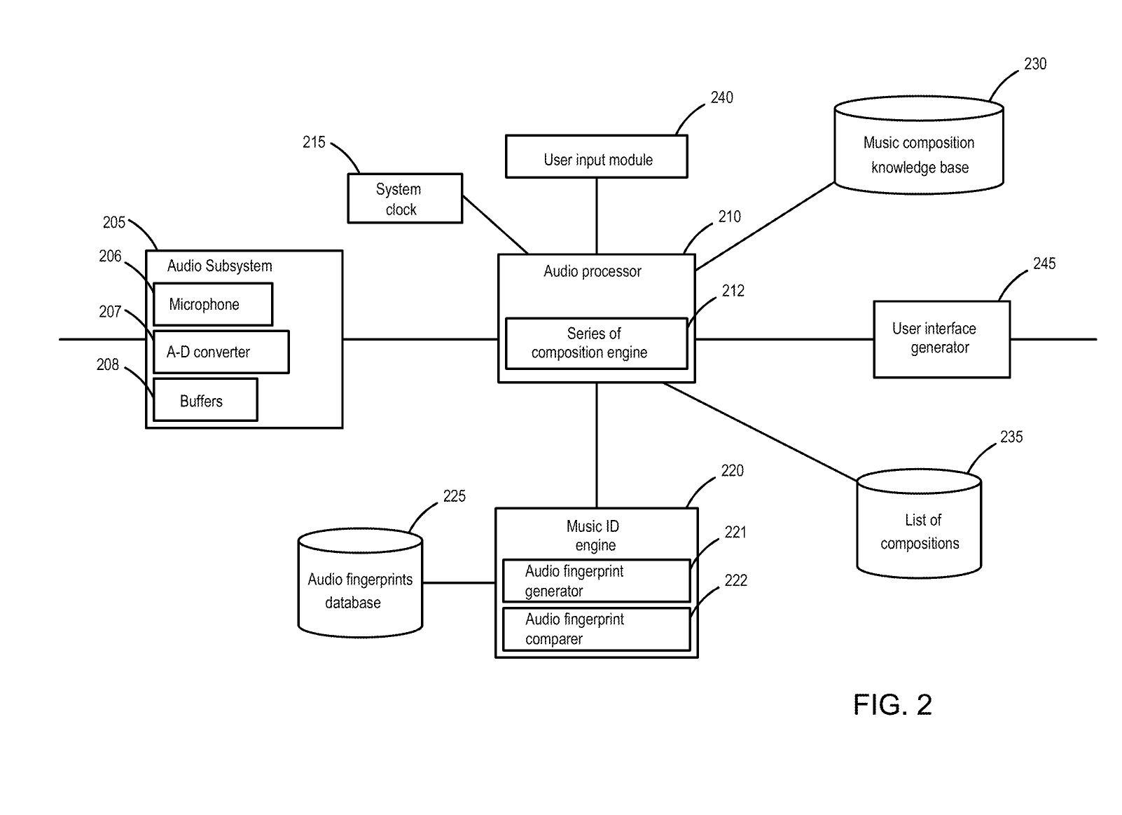

FIG. 2 is a diagram of an example system 200 for identifying a playlist in a power efficient manner. The system 200 may be implemented on a computing device such as the device 105. The device 105 includes an audio subsystem 205 with a microphone 206 to receive incoming audio. The audio subsystem 205 converts audio received through the microphone 206 to a digital signal using the analog-to-digital converter 207. The audio subsystem also includes buffers 208. The buffers 208 may store the digitized audio, e.g., in preparation for further processing by the system 200. In some implementations, the audio subsystem may contain multiple microphones, and in turn, each microphone may be associated with and connect to different analog-to-digital converters and/or buffers. One of the microphone may be used to identify items of media content and another microphone may be used for a phone call, video chat, or another voice application.

In some implementations, the audio subsystem 205 may include an input port such as an audio jack. The input port may be connected to, and receive audio from, an external device such as an external microphone, and be connected to, and provide audio to, the audio subsystem.

The audio subsystem 205 or particular components of the audio subsystem 205 are capable of being powered off or placed in a low power state. For example, the system 200 may disconnect the power supply to the microphone 206, the analog-to-digital converter 207, the buffers 208, or any other components of the audio subsystem 205. In some implementations, powering down the audio subsystem 205 or placing the audio subsystem 205 in a low power state prevents the audio subsystem 205 from being able to receive audio. For example, the audio subsystem 205 may be unable to receive audio because the microphone 206 is powered down. In some implementations, powering down the audio subsystem 205 or placing the audio subsystem 205 in a low power state prevents the audio subsystem 205 from being able to process audio. For example, the audio subsystem 205 may be unable process audio because the analog-to-digital converter 207 is in a low power state.

The audio processor 210 receives the digitized audio from the audio subsystem 205. The audio processor 210 gathers data from different components of the system 200 to determine a list of compositions that is being received by the system 200. The audio processor 210 includes a series of compositions engine 212 to process the data received from the different components of the system 200.

When the audio processor 210 receives the initial portion of the digitized audio, the audio processor 210 receives a timestamp from the system clock 215 and marks the initial portion of the digitized audio as received at that particular time. The audio processor 210 sends the digitized audio to the music identification engine 220. The music identification engine 220 generates audio fingerprints of the digitized audio using the audio fingerprint generator 221 and compares, using the audio fingerprint comparer 222, the generated audio fingerprints to audio fingerprints from the audio fingerprint database 225.

In some implementations, the audio processor 210 may send a particular portion of the digitized audio to the music identification engine 210. For example, the audio processor 210 may receive twenty seconds of digitized audio and send the twenty seconds of digitized audio to the music identification engine 220. The music identification engine 220 generates an audio fingerprint of the digitized audio and provides possible matches for the digitized audio along with corresponding confidence scores. The audio processor 210 determines an identity of the composition based on the confidence scores from the music identification engine 210. In some implementations, the audio processor 210 may select the identity of the composition that has the highest confidence score. In some implementations, the audio processor 210 may require that the highest confidence score satisfy a threshold. In instances where the highest confidence score does not satisfy a threshold, the audio processor 210 may provide additional digitized audio to the music identification engine 220. The music identification engine 220 may provide updated identities and corresponding confidence scores for the audio based on the additional digitized audio. The audio processor 210 may then select the highest confidence score that satisfies the threshold.

The music identification engine 220 may also determine and provide to the audio processor 210 the time within the composition where the portion received by the music identification engine 220 occurs. For example, the music identification engine 220 may receive twenty seconds of “Birthday Song.” The music identification engine 220 determines that those twenty seconds occur between 1:25 and 1:45 of the song and provides that information to the audio processor 210.

Once the audio processor 210 identifies the composition that corresponds to the digitized audio, the audio processor 210 accesses the music composition knowledge database 230. The music composition database 230 contains data related to different compositions including artist, title, length, publisher, and other information. The music composition database 230 may be contained within the device 105 or may be accessible through a network. The audio processor receives the additional information related to the identified composition and stores the information in the list of compositions 235.

Once the audio processor 210 determines the length of the identified song, the audio processor 210 deactivates the audio subsystem 205 for the remaining time in the identified song or the remaining time in the identified song plus additional time. The audio processor 210 compares the time when the audio processor 210 received the digitized audio from the audio subsystem to a current time when the audio processor received the length of composition from the music composition database 230. The audio processor 210 instructs the audio subsystem 205 to deactivate and after the remaining time of the composition has elapsed, the audio processor 210 instruct the audio subsystem 205 to reactivate.

By way of example, the audio processor 210 may begin receiving digitized audio of a song at the time of 1:42:11. At the time of 1:42:31, the audio processor 210 transmits the digitized audio to the music identification engine 220. The music identification engine 220 generates an audio fingerprint based on the twenty seconds of audio and determines that, among other confidence scores, that the confidence score of the generated fingerprint to the audio fingerprint of “Birthday Song” is eighty-four. The music identification engine 220 also determines that the received twenty seconds correspond to a portion of the song between 2:02 to 2:22. The confidence score of “Birthday Song” is the highest received from the music identification engine 220, and the audio processor 210 determines that “Birthday Song” matches the received audio. The audio processor 210 receives information from the music composition knowledge base 230 indicating that “Birthday Song” is four minutes and ten seconds long. Once the audio processor 210 has the length of “Birthday Song,” the audio processor determines that the current time is 1:42:36. With the 2:22 portion of the song occurring at a time of 1:42:31, the audio processor 210 determines that the song is currently at the 2:27 portion and that the song has one minute and forty three seconds remaining. The audio processor 210 instructs the audio subsystem 205 to deactivate and once the system clock reaches a time of 1:44:14, the audio processor 210 instructs the audio subsystem 205 to reactivate.

In some implementations, the audio subsystem 205 may receive a reactivation instruction and the audio subsystem 205 begins to receive and process new audio. The reactivation instruction is generated automatically by the audio processor 210 based on the instruction from the user to identify all the songs being played and based on the audio processor 210 determining that the previous song is expected to be finished. Once the audio subsystem is reactivated, the system 200 may determine that it is unable to identify the new audio or that the new audio matches the previous song. In these instances, the audio processor 210 may instruct the audio subsystem 205 to deactivate and then instruct the audio subsystem 205 to reactivate after a particular period of time. For example, if the audio processor 210 is unable to identify the next song, the audio processor may deactivate the audio subsystem and reactivate the audio subsystem after thirty seconds.

The user input module 240 receives input from a user and instructs the audio processor according to the received input. The user input module 240 may receive an instruction from the user to begin identifying audio compositions being received through the microphone. The user input module 240 may also receive an instruction from the user to stop identifying audio compositions. As an alternative to receiving an instruction from the user to stop identifying audio compositions, the audio processor 210 may stop identifying audio compositions if no audio that corresponds to audio compositions are received after a particular period of time.

The user interface generator 245 generates a user interface for display on a screen of the device 105. The user interface generator 245 may display information pertaining to each identified song such as the title, artist, length, a location to purchase the song, and any associate album artwork. The user interface generator 245 may also display the status of the audio subsystem 205, such as whether or not the audio subsystem 205 is active. The user interface generator 245 may display the list of identified compositions. The following morning, the user may instruct the device 105 to display the list of songs played and the user interface generator would generate the display for the device 105.

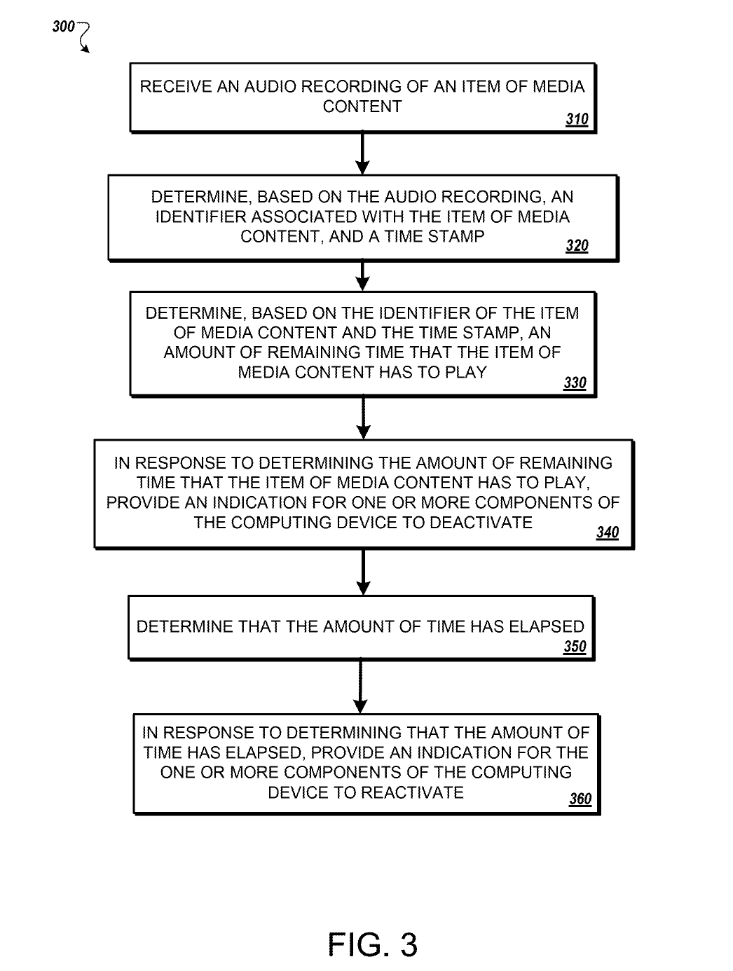

FIG. 3 is a diagram of an example process 300 for power efficient identification of a playlist. The process 300 may be performed by a computing device such as the device 105 from FIG. 1. The process 300 analyzes audio data, identifies items of media content, and in between identifications, places the device 105 is low power state.

The device 105 receives an audio recording of an item of media content (310). The device 105 may receive the audio recording through a microphone of the device 105 or through an audio jack of the device 105. The item of media content may be song, a commercial, or a movie trailer. The audio recording may be a particular length such as twenty seconds.

The device 105 determines an identifier associated with the item of media content, and a timestamp (320). The device 105 determines an audio fingerprint of the item of media content and compares that audio fingerprint to an audio fingerprint database. The device determines the audio fingerprint in the database that matches the audio fingerprint of the item of media content. Based on the audio fingerprint matching, the device determines the identity of the item of media content. As the device 105 receives the item of media content, the device records a timestamp that corresponds to when the device received the first portion of the item of media content. When matching the audio fingerprint of the item of media content with the audio fingerprints in the database, the device 105 determines the portion of the item of media content where the received audio occurs, such as between 1:05 and 1:25 of the item of media content.

In some implementations, to determine the identity of the item of media content, the device 105 will generated confidence scores based on the comparison of the audio fingerprint of the item of media content and each fingerprint in the audio fingerprint database. The device 105 may select the audio fingerprint in the database and fingerprint of the item of media content combination that produces the highest confidence score. In instances where the device 105 requires the confidence score to satisfy a threshold, the device 105 may use additional audio recordings from the item of media content to generate more audio fingerprints to compare to the audio fingerprints in the database.

The device 105 determines based on the identifier of the item of media content and the timestamp, an amount of remaining time that the item of media content has to play (330). The device 105 accesses a media item knowledge base that contains data associated with one or more media items. In accessing the media item knowledge base, the device 105 determines the length of the item of media content. By subtracting out the amount of time that the item of media content has already played, the device can determine the remaining time for the item of media content.

The device 105 provides, in response to determining the amount of remaining time that the item of media content has to play, providing an indication for one or more components of the device 105 to deactivate (340). In some implementations, the device 105 may instruct the microphone, analog-to-digital convert, buffers, or any combination of the three to deactivate. The device 105 may stop supplying power to one or more components of the audio subsystem. Alternatively, the device 105 may instruct the one or more component of the audio subsystem to enter a sleep or low power mode. In some implementations, the device 105 may instruct the display, the network adapter, and/or another component of the device 105 to deactivate, sleep, or enter low power mode.

The device 105 determines that the amount of time has elapsed (350). The device 105 monitors the system time to determine when the remaining time for the item of media content has elapsed. For example, the device 105 may be waiting for one and a half minutes to elapse. The system time when the device 105 began waiting was 15:23:19, then the device 105 would wait until the system time reached 15:24:49.

The device 105 provides, in response to determining that the amount of time has elapsed, an indication for the one or more components of the device 105 reactivate (360). In instances where the device 105 stopped supplying power to the one or more components of the audio subsystem, the device 105 would begin supplying power to the one or more components of the audio subsystem again. In instances where the device 105 instructed the one or more components of the audio subsystem to sleep or be in a low power state, the device 105 would instruct the one or more components of the audio subsystem to return to full power mode. In instances where the device 105 instructed the display, the network adapter, and/or another component of the device 105 to deactivate, sleep, or enter low power mode, the device 105 will instruct those particular components to reactivate.

The device 105 may store the identity of the item of media content in a list. Each subsequently identified item of media content may be appended to the list. The device 105 may receive an instruction from the user to display the list of items of media content. The device 105 then retrieves the list and displays the list on a screen of the device 105.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving, by a computing device, an audio recording of an item of media content;
determining, based on the audio recording, an identifier associated with the item of media content, and a timestamp;
determining, based on the identifier of the item of media content and the timestamp, an amount of remaining time that the item of media content has to play;
in response to determining the amount of remaining time that the item of media content has to play, providing an indication for one or more components of the computing device to deactivate;
determining that the amount of time has elapsed; and
in response to determining that the amount of time has elapsed, providing an indication for the one or more components of the computing device to reactivate.

2. The method of claim 1, wherein determining an identifier associated with the item of media content, and a timestamp comprises:
determining an audio fingerprint of the item of media content;
comparing the audio fingerprint of the item of media content to one or more audio fingerprints; and
based on comparing the audio fingerprint of the item of media content to the one or more audio fingerprints, determining an identifier associated with the item of media content.

3. The method of claim 2, wherein comparing the audio fingerprint of the item of media content to one or more audio fingerprints comprises determining a confidence score, and
wherein determining an identifier associated with the item of media content, and a timestamp is based further on determining that the confidence score satisfies a threshold.

4. The method of claim 1, wherein determining that the amount of time has elapsed comprises:
accessing a media item knowledge base that contains data associated with one or more items of media content.

5. The method of claim 1, wherein providing an indication for one or more components of the computing device to deactivate comprises:
providing an indication to deactivate one or more of a microphone, an analog-to-digital converter, or an audio buffer.

6. The method of claim 1, wherein the item of media content is a song, a commercial, or a movie trailer.

7. The method of claim 1, comprising:
accessing data associated with the item of media content from a media item knowledge base that contains data associated with one or more items of media content;
storing the data associated with the item of media content;
receiving a request to display the data associated with the item of media content; and
displaying the data associated with the item of media content.

8. The method of claim 1, wherein providing an indication for one or more components of the computing device to deactivate comprises providing an indication for the one or more components of the computing device to reduce a power consumption of the computing device.

9. The method of claim 1, wherein:
providing an indication for one or more components of the computing device to deactivate comprises providing an indication for one or more components of an audio subsystem of the computing device to deactivate, and
providing an indication for the one or more components of the computing device to reactivate comprises providing an indication for the one or more components of the audio subsystem of the computing device to reactivate.

10. A system comprising:
one or more computers and one or more storage devices storing instructions that are operable, when executed by the one or more computers, to cause the one or more computers to perform operations comprising:
receiving, by a computing device, an audio recording of an item of media content;
determining, based on the audio recording, an identifier associated with the item of media content, and a timestamp;
determining, based on the identifier of the item of media content and the timestamp, an amount of remaining time that the item of media content has to play;
in response to determining the amount of remaining time that the item of media content has to play, providing an indication for one or more components of the computing device to deactivate;
determining that the amount of time has elapsed; and
in response to determining that the amount of time has elapsed, providing an indication for the one or more components of the computing device to reactivate.

11. The system of claim 10, wherein determining an identifier associated with the item of media content, and a timestamp comprises:
determining an audio fingerprint of the item of media content;
comparing the audio fingerprint of the item of media content to one or more audio fingerprints; and
based on comparing the audio fingerprint of the item of media content to the one or more audio fingerprints, determining an identifier associated with the item of media content.

12. The system of claim 11, wherein comparing the audio fingerprint of the item of media content to one or more audio fingerprints comprises determining a confidence score, and
wherein determining an identifier associated with the item of media content, and a timestamp is based further on determining that the confidence score satisfies a threshold.

13. The system of claim 10, wherein determining that the amount of time has elapsed comprises:
accessing a media item knowledge base that contains data associated with one or more items of media content.

14. The system of claim 10, wherein providing an indication for one or more components of the computing device to deactivate comprises:
providing an indication to deactivate one or more of a microphone, an analog-to-digital converter, or an audio buffer.

15. The system of claim 10, wherein the item of media content is a song, a commercial, or a movie trailer.

16. The system of claim 10, wherein the operations further comprise:
accessing data associated with the item of media content from a media item knowledge base that contains data associated with one or more items of media content;
storing the data associated with the item of media content;
receiving a request to display the data associated with the item of media content; and
displaying the data associated with the item of media content.

17. The system of claim 10, wherein providing an indication for one or more components of the computing device to deactivate comprises providing an indication for the one or more components of the computing device to reduce a power consumption of the computing device.

18. The system of claim 10, wherein:
providing an indication for one or more components of the computing device to deactivate comprises providing an indication for one or more components of an audio subsystem of the computing device to deactivate, and
providing an indication for the one or more components of the computing device to reactivate comprises providing an indication for the one or more components of the audio subsystem of the computing device to reactivate.

19. A non-transitory computer-readable medium storing software comprising instructions executable by one or more computers which, upon such execution, cause the one or more computers to perform operations comprising:
receiving, by a computing device, an audio recording of an item of media content;
determining, based on the audio recording, an identifier associated with the item of media content, and a timestamp;
determining, based on the identifier of the item of media content and the timestamp, an amount of remaining time that the item of media content has to play;
in response to determining the amount of remaining time that the item of media content has to play, providing an indication for one or more components of the computing device to deactivate;
determining that the amount of time has elapsed; and
in response to determining that the amount of time has elapsed, providing an indication for the one or more components of the computing device to reactivate.

20. The medium of claim 19, wherein the operations further comprise:
accessing data associated with the item of media content from a media item knowledge base that contains data associated with one or more items of media content;
storing the data associated with the item of media content;
receiving a request to display the data associated with the item of media content; and
displaying the data associated with the item of media content.
